(19) United States
(12) Patent Application Publication
(10) Pub. No.: US 2025/0233716 A1
(43) Pub. Date: Jul. 17, 2025

(54) COMMUNICATION SYSTEM

(71) Applicant: NEC Corporation, Minato-ku, Tokyo (JP)

(72) Inventors: Caroline LIANG, Guildford (GB); Yuhua CHEN, London (GB); Robert ARNOTT, London (GB)

(73) Assignee: NEC Corporation, Minato-ku, Tokyo (JP)

(21) Appl. No.: 18/852,739

(22) PCT Filed: Apr. 10, 2023
(86) PCT No.: PCT/JP2023/014634

§ 371 Date: Sep. 30, 2024

(30) Foreign Application Priority Data
Apr. 22, 2022 (GB) 2205935.6

(51) Int. Cl. H04L 5/00; H04W 72/11; H04W 72/232

(52) U.S. Cl. CPC H04L 5/0078; H04L 5/0053; H04W 72/11; H04W 72/232

(57) ABSTRACT

A system (1) is disclosed in which a user equipment (UE) (3) receives configuration information for determining at least one position of a resource for transmission/reception associated with a data stream. The configuration information includes information identifying a first periodicity and information identifying an offset for applying to the first periodicity. The UE (3) adjusts the offset based on a frame rate or a second periodicity associated with the data stream.

### TECHNICAL FIELD

The present disclosure relates to a wireless communication system and devices thereof operating according to the 3rd Generation Partnership Project (3GPP) standards or equivalents or derivatives thereof. The disclosure has particular but not exclusive relevance to improvements relating to power saving techniques in the so-called ‘5G’ or ‘New Radio’ systems (also referred to as ‘Next Generation’ systems) and similar systems.

### BACKGROUND ART

Under the 3GPP standards, a NodeB (or an ‘eNB’ in LTE, ‘gNB’ in 5G) is a base station via which communication devices (user equipment or ‘UE’) connect to a core network and communicate to other communication devices or remote servers. Communication devices might be, for example, mobile communication devices such as mobile telephones, smartphones, smart watches, personal digital assistants, laptop/tablet computers, web browsers, e-book readers, and/or the like. Such mobile (or even generally stationary) devices are typically operated by a user (and hence they are often collectively referred to as user equipment, ‘UE’) although it is also possible to connect Internet of Things (IoT) devices and similar Machine Type Communications (MTC) devices to the network. For simplicity, the present application will use the term base station to refer to any such base stations and use the term mobile device or UE to refer to any such communication device.

The latest developments of the 3GPP standards are the so-called ‘5G’ or ‘New Radio’ (NR) standards which refer to an evolving communication technology that is expected to support a variety of applications and services such as MTC/IoT communications, vehicular communications and autonomous cars, high resolution video streaming, smart city services, and/or the like. 3GPP intends to support 5G by way of the so-called 3GPP Next Generation (NextGen) radio access network (RAN) and the 3GPP NextGen core (NGC) network. Various details of 5G networks are described in, for example, the ‘NGMN 5G White Paper’ V1.0 (NPL 1).

End-user communication devices are commonly referred to as User Equipment (UE) which may be operated by a human or comprise automated (MTC/IoT) devices. Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). 3GPP Technical Specification (TS) 38.300 V16.7.0 (NPL 2) and 3GPP TS 37.340 V16.7.0 (NPL 3) define the following nodes, amongst others:

gNB: node providing NR user plane and control plane protocol terminations towards the UE, and connected via the NG interface to the 5G core network (5GC).

ng-eNB: node providing Evolved Universal Terrestrial Radio Access (E-UTRA) user plane and control plane protocol terminations towards the UE, and connected via the NG interface to the 5GC.

En-gNB: node providing NR user plane and control plane protocol terminations towards the UE, and acting as Secondary Node in E-UTRA-NR Dual Connectivity (EN-DC).

NG-RAN node: either a gNB or an ng-eNB.

The term base station or RAN node is used herein to refer to any such node.

The next-generation mobile networks support diversified service requirements, which have been classified into three categories by the International Telecommunication Union (ITU): Enhanced Mobile Broadband (eMBB); Ultra-Reliable and Low-Latency Communications (URLLC); and Massive Machine Type Communications (mMTC). eMBB aims to provide enhanced support of conventional mobile broadband, with focus on services requiring large and guaranteed bandwidth such as High Definition (HD) video, Virtual Reality (VR), and Augmented Reality (AR). URLLC is a requirement for critical applications such as automated driving and factory automation, which require guaranteed access within a very short time. MMTC needs to support massive number of connected devices such as smart metering and environment monitoring but can usually tolerate certain access delay. It will be appreciated that some of these applications may have relatively lenient Quality of Service/Quality of Experience (QoS/QoE) requirements, while some applications may have relatively stringent QoS/QoE requirements (e.g. high bandwidth and/or low latency).

Communication between the UEs and the base station is controlled using the so-called Radio Resource Control (RRC) protocol. The base station may optimise power consumption for the UE(s) by configuring a so-called Discontinuous Reception (DRX) and/or Discontinuous Transmission (DTX) operation. Both DRX and DTX are based on reducing the UE's transceiver duty cycle while in active operation. In DRX mode, the base station sets a cycle during which the UE is operational for a certain period of time (referred to as ‘active time’ or ‘on duration’) and the base station transmits all scheduling and paging information (for this UE) during this period only. The UE can thus turn off its transceiver for the rest of the DRX cycle (which may also be referred to as ‘inactive time’ or ‘off duration’). In DTX mode, the UE does not turn off its transceiver completely, but keeps monitoring the Physical Downlink Control Channel (PDCCH) to be able to receive data from the base station without undue delay. The longer the ‘off’ duration relative to the duty cycle, the more power saving can be achieved. However, when operating in DRX and/or DTX mode, the UE's data throughput is reduced in proportion to the achieved power savings since the UE can transmit/receive during the active time only.

The term extended reality (XR) refers to all real-and-virtual combined environments and associated human-machine interactions generated by computer technology and wearables. It includes representative forms such as augmented reality (AR), mixed reality (MR), and virtual reality (VR) and the areas interpolated among them. XR and Cloud Gaming (CG) are among the most important 5G media applications under consideration in the industry.

3GPP Technical Report (TR) 26.928 V16.1.0 (NPL 4) discusses eXtended Reality (XR) in the context of 5G radio and network services. This document introduces baseline technologies for XR type of services and applications, outlining the quality of experience (QoE)/quality of service (QoS) issues of XR-based services, the delivery of XR in 5G systems, and an architectural model of 5G media streaming defined in 3GPP TS 26.501 V16.9.0 (NPL 5). In addition to the conventional service category, interactive, streaming, download, and split compute/rendering are identified as new delivery categories for XR. 3GPP TR 38.838 V17.0.0 (NPL 6) is a study on XR service and in particular the traffic models and characteristics aspects of XR in Release 17.

### CITATION LIST

### Non Patent Literature

NPL 1: ‘NGMN 5G White Paper’ V1.0, the Next Generation Mobile Networks (NGMN) Alliance, February 2015, https://ngmn.org/wp-content/uploads/NGMN_5G_White_Paper_V1_0.pdf
NPL 2: 3GPP TS 38.300, “NR; NR and NG-RAN Overall Description; Stage 2”, V16.7.0 (2021-09)
NPL 3: 3GPP TS 37.340, “Evolved Universal Terrestrial Radio Access (E-UTRA) and NR; Multi-connectivity; Stage 2”, V16.7.0 (2021-09)
NPL 4: 3GPP TR 26.928, “Extended Reality (XR) in 5G”, V16.1.0 (2020-12)
NPL 5: 3GPP TS 26.501, “5G Media Streaming (5GMS); General description and architecture”, V16.9.0 (2021-12)
NPL 6: 3GPP TR 38.838, “Study on XR (Extended Reality) Evaluations for NR”, V17.0.0 (2021-12)
NPL 7: 3GPP TS 38.213, “NR; Physical layer procedures for control”, V16.8.0 (2021-12)
NPL 8: 3GPP TS 38.321, “NR; Medium Access Control (MAC) protocol specification”, V16.7.0 (2021-12)
NPL 9: 3GPP TS 38.214, “NR; Physical layer procedures for data”, V16.8.0 (2021-12)
NPL 10: 3GPP TS 22.368, “Service requirements for Machine-Type Communications (MTC); Stage 1”, V13.1.0 (2014-12)

### SUMMARY OF INVENTION

### Technical Problem

In case of XR and CG, the packet arrival rate is determined by the frame generation rate, e.g. 60 fps or 120 fps. The average packet arrival periodicity is given by the inverse of the frame rate, e.g. 16.6667 ms= 1/60 fps or 8.3333 ms= 1/120 fps. The periodic arrival time at the base station, without any jitter, for packet with index k (=1,2,3, . . . ) can be expressed as k/F*1000 [ms].

Multi-stream services are modelled based on single stream services. For example, two related streams (separate video streams for left eye and right eye) may be transmitted at 60 fps with the same jitter model as for a single stream. For the so-called Group-Of-Picture (GOP) based traffic model, one video frame arrives at a time as a packet like in case of a single stream.

XR video traffic is similar to MBB services in the sense that its application PDU size is varying just as FTP or web browsing. On the other hand, the arrival time or periodicity of traffic generation is more predictable than that of MBB services (since video has a fixed frame refresh rate). From this angle, XR traffic characteristics are more similar to periodic traffic such as voice and motion control in industrial applications. Similarly to industrial control applications, XR requires bounded latency, and a reasonably high reliability. Traditional mechanisms and strategies to perform resource allocation used for MBB or for voice/motion control may be suboptimal for XR.

Although dynamic scheduling may be used to deal with the varying frame size associated with XR traffic, this would involve overhead control signalling (PDCCH, Scheduling Requests), and could cause increased latency. Due to the large Protocol Data Unit (PDU) size, the network will usually need to allocate several slots to deliver all the packets associated with a single Application Data Unit (ADU) which may make dynamic scheduling difficult to use in some cases.

For predictable arrival times, it is possible to use so-called configured grants (e.g. Semi-Persistent Scheduling (SPS) and/or the like). However, they may not be suitable to handle large and varying video frame sizes, due to their fixed resource allocation.

Various UE power saving enhancements are being considered for Release-17. One of such enhancements is the PDCCH monitoring adaptation indication for informing a UE when it is allowed to skip monitoring of the subsequent PDCCH. The indication may consist of 0, 1, or 2 bits, depending on configuration such as the number of durations and search space groups configured for the UE. In more detail, a UE can be provided a set of durations by PDCCHSkippingDurationList for PDCCH monitoring on a serving cell and, if the UE is not provided searchSpaceGroupIdList-r17, a DCI format 0_1, and/or DCI format 1_1, and/or DCI format 0_2, and/or DCI format 1_2 that schedules a Physical Downlink Shared Channel (PUSCH) transmission or a Physical Uplink Shared Channel (PDSCH) reception can include a PDCCH monitoring adaptation field of 1 bit or of 2 bits. The bits indicate either no skipping in PDCCH monitoring or skipping PDCCH monitoring for a duration provided by the first/second/third value (if applicable) in the set of durations.

Alternatively, if the UE is not provided a PDCCHSkippingDurationList, the UE can be provided group indexes for a Type3-PDCCH CSS set or USS set by searchSpaceGroupIdList-r17 for PDCCH monitoring on a serving cell. In this case, a DCI format 0_1, or DCI format 1_1, or DCI format 0_2, or DCI format 1_2 that schedules a PUSCH transmission or a PDSCH reception can include a PDCCH monitoring adaptation field of 1 bit or of 2 bits, which indicate the group index associated with the search space sets over which the UE needs to start PDCCH monitoring (and stop PDCCH monitoring according to search space sets with any other group indexes).

However, the currently proposed power saving enhancements do not take into account delay critical traffic, such as XR traffic. Moreover, since XR traffic periodicity is much shorter than that of a typical eMBB traffic, signalling resource overhead and PDCCH blocking rate caused by the downlink control information (DCI) based power saving enhancements proposed for Release-17 would not be neglectable. For example, the wake-up indication carried by DCI format 2_6 may not be useful for XR traffic due to the relatively short XR traffic periodicity (e.g. 8.33 ms, 16.67 ms). The currently proposed power saving enhancements also do not work well with low latency traffic and non-integer periodicity (e.g. 8.33 ms, 16.67 ms).

Accordingly, the present disclosure seeks to provide methods and associated apparatus that address or at least alleviate (at least some of) the above-described issues.

### Solution to Problem

In one aspect, the present disclosure provides a method performed by a user equipment (UE), the method comprising: receiving configuration information for determining at least one position of a resource for transmission/reception associated with a data stream, the configuration information including information identifying a first periodicity and information identifying an offset for applying to the first periodicity; and adjusting the offset based on a frame rate or a second periodicity associated with the data stream.

In one aspect, the present disclosure provides a method performed by a user equipment (UE), the method comprising: receiving configuration information for monitoring of a search space associated with a data stream, the configuration information including information identifying a periodicity for the monitoring of the search space and information identifying a first offset; and adjusting the first offset based on a frame rate or a periodicity associated with the data stream.

In one aspect, the present disclosure provides a method performed by a user equipment (UE), the method comprising: receiving configuration information for a configured grant associated with a data stream, the configuration information including information identifying a first periodicity for the configured grant and information identifying a slot level offset; and adjusting a symbol level offset derived based on a frame rate or a second periodicity associated with the data stream.

In one aspect, the present disclosure provides a method performed by a base station, the method comprising: transmitting, to a user equipment (UE), configuration information for determining at least one position of a resource for transmission/reception associated with a data stream, the configuration information including information identifying a first periodicity and information identifying an offset for applying to the first periodicity; and adjusting the offset in a unit of slots or a unit of symbols based on a frame rate associated with the data stream.

In one aspect, the present disclosure provides a user equipment (UE) comprising: means (for example a memory, a controller, and a transceiver) for receiving configuration information for determining at least one position of a resource for transmission/reception associated with a data stream, the configuration information including information identifying a first periodicity and information identifying an offset for applying to the first periodicity; and means for adjusting the offset based on a frame rate or a second periodicity associated with the data stream.

In one aspect, the present disclosure provides a base station comprising: means (for example a memory, a controller, and a transceiver) for transmitting, to a user equipment (UE), configuration information for determining at least one position of a resource for transmission/reception associated with a data stream, the configuration information including information identifying a first periodicity and information identifying an offset for applying to the first periodicity; and means for adjusting the offset in a unit of slots or a unit of symbols based on a frame rate associated with the data stream.

Aspects of the present disclosure extend to corresponding systems, apparatus, and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Although for efficiency of understanding for those of skill in the art, the present disclosure will be described in detail in the context of a 3GPP system (5G networks), the principles of the present disclosure can be applied to other systems as well.

The present disclosure is defined by the claims appended hereto. Aspects of the present disclosure are as set out in the independent claims. Some optional features are set out in the dependent claims.

However, each feature disclosed in this specification (which term includes the claims) and/or shown in the drawings may be incorporated in the present disclosure independently of (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

Example embodiments of the present disclosure will now be described, by way of example, with reference to the accompanying drawings in which:

FIG. 1 illustrates schematically a mobile (cellular or wireless) telecommunication system to which example embodiments of the present disclosure may be applied;

FIG. 2 is a schematic block diagram of a mobile device forming part of the system shown in FIG. 1;

FIG. 3 is a schematic block diagram of an access network node (e.g. base station) forming part of the system shown in FIG. 1;

FIG. 4 is a schematic block diagram of a core network node forming part of the system shown in FIG. 1; and

FIG. 5 illustrates an exemplary scenario to which the present disclosure is applicable.

### DESCRIPTION OF EMBODIMENTS

### Overview

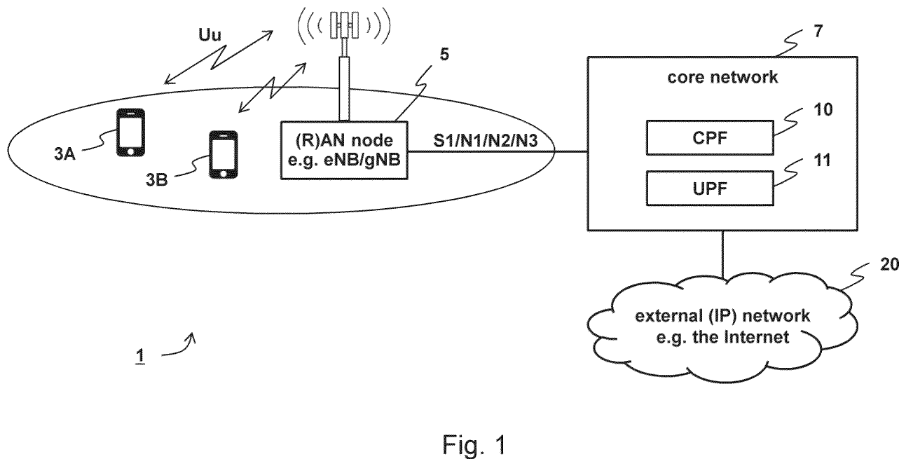

FIG. 1 illustrates schematically a mobile (cellular or wireless) telecommunication system 1 to which example embodiments of the present disclosure may be applied.

In this system 1, users of mobile devices 3 (UEs) can communicate with each other and other users via base stations 5 (and other access network nodes) and a core network 7 using an appropriate 3GPP radio access technology (RAT), for example, an Evolved Universal Terrestrial Radio Access (E-UTRA) and/or a 5G RAT. It will be appreciated that a number of base stations 5 form a (radio) access network or (R)AN. As those skilled in the art will appreciate, whilst two mobile devices 3A and 3B and one base station 5 are shown in FIG. 1 for illustration purposes, the system, when implemented, will typically include other base stations/(R)AN nodes and mobile devices (UEs).

Each base station 5 controls one or more associated cell (either directly or via other nodes such as home base stations, relays, remote radio heads, distributed units, and/or the like). A base station 5 that supports Next Generation/5G protocols may be referred to as a ‘gNBs’. It will be appreciated that some base stations 5 may be configured to support both 4G and 5G, and/or any other 3GPP or non-3GPP communication protocols.

The mobile device 3 and its serving base station 5 are connected via an appropriate air interface (for example the so-called ‘NR’ air interface, the ‘Uu’ interface, and/or the like). Neighbouring base stations 5 are connected to each other via an appropriate base station to base station interface (such as the so-called ‘Xn’ interface, the ‘X2’ interface, and/or the like). The base stations 5 are also connected to the core network nodes via an appropriate interface (such as the so-called ‘NG-U’ interface (for user-plane), the so-called ‘NG-C’ interface (for control-plane), and/or the like).

The core network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the core network 7 of a ‘Next Generation’/5G system will include user plane entities and control plane entities, such as one or more control plane functions (CPFs) 10 and one or more user plane functions (UPFs) 11. For example, the so-called Access and Mobility Management Function (AMF) in 5G, or the Mobility Management Entity (MME) in 4G, is responsible for handling connection and mobility management tasks for the mobile devices 3, and the Session Management Function (SMF) is responsible for handling communication sessions for the mobile devices 3 such as session establishment, modification and release. The core network 7 is coupled (via the UPF 11) to a data network (external (IP) network) 20, such as the Internet or a similar Internet Protocol (IP) based network.

It will be appreciated that each mobile device 3 may support one or more services which may fall into one of the categories defined above (URLLC/eMBB/mMTC). Each service will typically have associated requirements (e.g. latency/data rate/packet loss requirements, etc.), which may be different for different services. Each mobile device may be configured with appropriate power saving operation such as DRX, DTX, and/or the like. The power saving operation may depend on the category of the service(s) used, UE capabilities, and other factors (such as QoE/QoS, throughput, serving cell(s), network load, and/or the like).

In this system, the PDCCH monitoring and transmissions can be adapted to support XR traffic (or CG traffic and/or the like) without sacrificing power saving at the UE 3.

In this system, PDCCH monitoring is adapted for XR (or CG) services. Specifically, the periodicity and offset of PDCCH monitoring is adjusted to support the specific periodicity of the XR traffic such as 8.33 ms or 16.67 ms, or any other such ‘non-integer’ periodicity. Since it is not an integer value, the PDCCH search space configuration is adjusted when necessary.

The UE 3 is configured with the applicable search space set and/or the adjustment to the search space set via appropriate control signalling, for example, RRC signalling including an appropriately formatted information element. The search space set configuration includes information relating to an additional offset that indicates the difference between multiple of PDCCH periodicities and XR packet arrival timing. The additional offset is applied by the UE 3 to determine whether or not a current slot is included in the search space set for that UE 3.

In more detail, the UE 3 and the network may employ one or more of the following options for configuring the UE 3 with an appropriate XR specific offset:
Option 1: The XR specific offset may be activated/deactivated via a suitable DCI field. In this case, the field may be set to an appropriate value e.g. ‘1’ (or ‘11’ when 2 bits are used) to activate or deactivate the XR specific offset (if it is already activated).
Option 2: XR specific PDCCH monitoring may be supported via specific (new) values of the ‘monitoringSlotPeriodicityAndOffset’ information element. For example, one of the following values may be used: ‘sl8’, ‘sl17’, ‘sl32’, ‘sl33’, ‘sl64’, ‘sl66’, ‘sl128’, ‘sl133’, ‘sl256’, and ‘sl266’.
Option 3: A suitable DCI field (such as the PDCCH monitoring adaptation field) may be used to set an appropriate jitter offset when necessary. Such a jitter offset may be used to shift the start offset of PDCCH monitoring (by +/−‘jitter offset’ value), for at least one of the periodic PDCCH monitoring occasions. The jitter offset value may be given in a number of slots for example.
Option 4: In order to adjust the start offset of a configured uplink grant, a symbol level offset may be used. For example, such a symbol level (‘kOffsetSymbols’) may be derived using the following formula:

$$kOffsetSymbols = ⌈ ( 1000 ms / fps * 2 \hat{} μ * numberOfSymbolsPerSlot - periodicity\_sym ) * N ⌉$$

where ‘N’ is for N^{th} grant, and ‘periodicity_sym’ is the applicable periodicity (see Table 2).

In order to provide improved support for XR traffic, this symbol level offset may be taken into account when determining the position of the configured uplink grant.

Once the start (symbol/slot) of the configured uplink grant has been determined (e.g. based on the ‘kOffsetSymbols’), the UE 3 can transmit uplink data for a number of consecutive slots of the configured grant burst. The number of consecutive slots may be indicated using a suitable DCI field (e.g. the ‘cg-nrofSlots’ field).

In summary, the UE 3 receives configuration information for determining at least one position of a resource for transmission/reception associated with a data stream, the configuration information including information identifying a periodicity and information identifying an offset. The UE 3 calculates/adjusts the offset, on a slot and/or a symbol level, based on the frame rate associated with the data stream (e.g. 60 fps or 120 fps).

### User Equipment (UE)

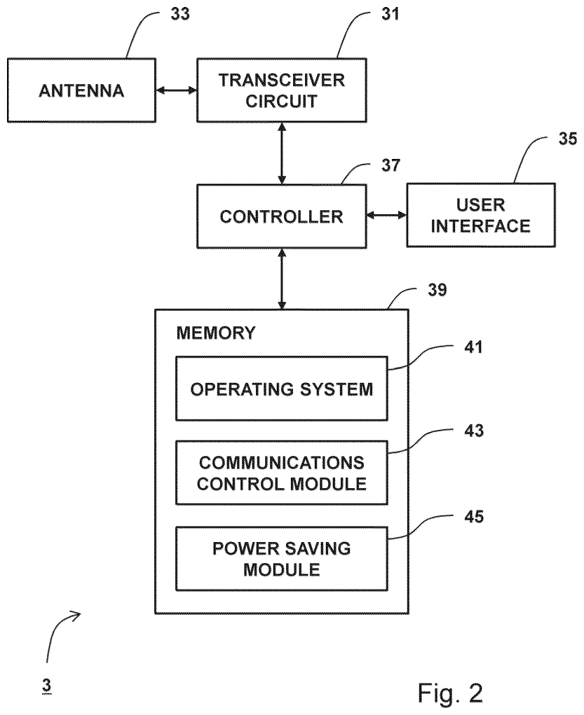

FIG. 2 is a block diagram illustrating the main components of the mobile device (UE) 3 shown in FIG. 1. As shown, the UE 3 includes a transceiver circuit 31 which is operable to transmit signals to and to receive signals from the connected node(s) via one or more antenna 33. Although not necessarily shown in FIG. 2, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41, a communications control module 43, and a power saving module 45 (such as a DRX module).

The communications control module 43 is responsible for handling (generating/sending/receiving) signalling messages and uplink/downlink data packets between the UE 3 and other nodes, including (R)AN nodes 5 and core network nodes. The signalling may comprise control signalling (e.g. via RRC/MAC/PHY/DCI) related to the power saving operation and/or configured grant. It will be appreciated that the communications control module 43 may include a number of sub-modules (‘layers’ or ‘entities’) to support specific functionalities. For example, the communications control module 43 may include a PHY sub-module, a MAC sub-module, an RLC sub-module, a PDCP sub-module, an SDAP sub-module, an IP sub-module, an RRC sub-module, etc.

The power saving/DRX module 45 is responsible for obtaining appropriate configuration (e.g. via the communications control module 43) for a power saving operation. Power saving is typically achieved by turning off certain components (e.g. the transceiver circuit 31) for certain periods and by monitoring PDCCH discontinuously (only during specific slots/symbols). When discontinuous reception (DRX) is used, the power saving module 45 includes DRX control functionality.

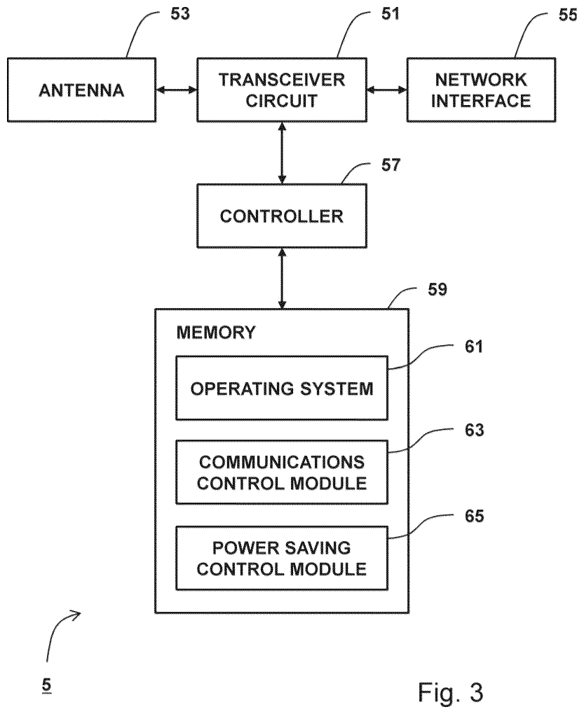

Access network node (base station) FIG. 3 is a block diagram illustrating the main components of the base station 5 (or a similar access network node) shown in FIG. 1. As shown, the base station 5 includes a transceiver circuit 51 which is operable to transmit signals to and to receive signals from connected UE(s) 3 via one or more antenna 53 and to transmit signals to and to receive signals from other network nodes (either directly or indirectly) via a network interface 55. The network interface 55 typically includes an appropriate base station—base station interface (such as X2/Xn) and an appropriate base station—core network interface (such as S1/N1/N2/N3). A controller 57 controls the operation of the base station 5 in accordance with software stored in a memory 59. The software may be pre-installed in the memory 59 and/or may be downloaded via the telecommunication network 1 or from a removable data storage device (RMD), for example. The software includes, among other things, an operating system 61, a communications control module 63, and a power saving control module 65.

The communications control module 63 is responsible for handling (generating/sending/receiving) signalling between the base station 5 and other nodes, such as the UE 3 and the core network nodes. The signalling may comprise control signalling (e.g. via RRC/MAC/PHY/DCI) related to the power saving operation and/or configured grant. It will be appreciated that the communications control module 63 may include a number of sub-modules (‘layers’ or ‘entities’) to support specific functionalities. For example, the communications control module 63 may include a PHY sub-module, a MAC sub-module, an RLC sub-module, a PDCP sub-module, an SDAP sub-module, an IP sub-module, an RRC sub-module, etc.

The power saving control module 65 is responsible for providing appropriate configuration for the UE 3 (e.g. via the communications control module 63) for a power saving operation applicable to that UE 3. When power saving is achieved using discontinuous reception (DRX), the power saving control module 65 includes DRX control functionality.

### Core Network Function

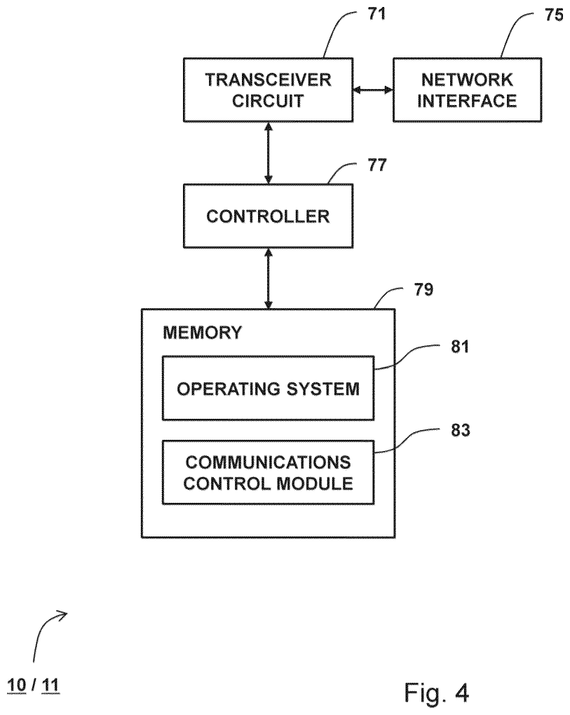

FIG. 4 is a block diagram illustrating the main components of a generic core network function, such as the CPF 10 or the UPF 11 shown in FIG. 1. As shown, the core network function includes a transceiver circuit 71 which is operable to transmit signals to and to receive signals from other nodes (including the UE 3, the base station 5, and other core network nodes) via a network interface 75. A controller 77 controls the operation of the core network function in accordance with software stored in a memory 79. The software may be pre-installed in the memory 79 and/or may be downloaded via the telecommunication network 1 or from a removable data storage device (RMD), for example. The software includes, among other things, an operating system 81, and a communications control module 83.

The communications control module 83 is responsible for handling (generating/sending/receiving) signaling between the core network function and other nodes, such as the UE 3, the base station 5, and other core network nodes.

### DETAILED DESCRIPTION

XR traffic is often characterised by multiple data flows (e.g. separate flow for left eye and right eye, separate audio data). In the so-called dual eye buffer model of data, the left and right eye frames arrive separately. In certain two stream models, XR video and audio streams may have different periodicities (e.g. 16.6667 and 10 ms, respectively), different packet delay budgets (e.g. 10 ms vs 30 ms), and different packet sizes. Thus, it may be difficult to configure PDCCH monitoring that is suitable for XR/CG traffic, using existing techniques whilst also benefitting from optimal power savings.

In order to allow the UE 3 achieve some power savings, the UE 3 does not need to monitor the PDCCH continuously even when it has ongoing communication sessions relating to one or more service. With DRX/connected mode DRX (C-DRX), data transmissions for the UE 3 may be scheduled (may take place) during the active time of that UE 3. In case of XR traffic, and some type of CG traffic, the active time of the UE 3 can be aligned with the arrival periodicity of the packets, at least on a slot level.

In order to address potential timing mismatch and jitter in case of certain data streams, such as XR/CG data streams, a number of solutions will be discussed in the following. It will be appreciated that certain aspects of the various solutions may be applicable to (or combined with) all solutions even if it is not expressly stated in the relevant description.

### Solution 1

In this solution, PDCCH monitoring is adapted for XR (or CG) services. Specifically, the periodicity and offset of PDCCH monitoring is adjusted to support the specific periodicity of the XR traffic such as 8.33 ms or 16.67 ms, for example. Since it is not an integer value, the PDCCH search space configuration may need to be periodically adjusted, using any of the following methods.

In case of XR, the necessary adjustments to the applicable search space configuration can be predetermined, since for XR the DL/UL traffic characteristics can be known upon the arrival of the first packet(s).

The UE 3 may be configured with the applicable search space set and/or the adjustment to the search space set via appropriate control signalling, for example, RRC signalling including an appropriately formatted information element. The signalling (information element) may carry the search space set configuration for the UE 3, including information relating to an additional offset that indicates the difference between multiple of PDCCH periodicities and XR packet arrival timing. The additional offset may be referred to as an ‘XR specific offset’, ‘fps specific offset’, ‘search space adjustment offset’, or similar, and it may be defined as a fraction of a slot for example. The additional offset is applied by the UE 3 to determine whether or not a current slot is included in the search space set for that UE 3. Effectively, using such an XR specific offset, the UE 3 can determine when (after how many periodic occurrences of the search space set) it needs to adjust the search space set to align with the PDCCH corresponding to the arrival of the XR traffic. This approach is more power efficient and requires less control signalling than switching the search space via dynamic scheduling/DCI since the search space set configuration needs to be provided to the UE 3 only once (when the XR stream starts). Alternatively, the search space set configuration may be derived by the UE 3 implicitly, based on the characteristics of the received stream or from information included in the stream (e.g. frame rate information).

It will be appreciated that the following options may be followed when configuring the UE 3 with the XR specific offset:
Option 1: The XR specific offset may be activated/deactivated by a suitable DCI field, such as the PDCCH monitoring adaptation field of a DCI format 0_1, and/or DCI format 1_1, and/or DCI format 0_2, and/or DCI format 1_2 that schedules a PUSCH transmission or a PDSCH reception (e.g. if the UE 3 is not provided searchSpaceGroupTdList-r17) or the PDCCH monitoring adaptation field of a DCI format 0_1, or DCI format 1_1, or DCI format 0_2, or DCI format 1_2 that schedules a PUSCH transmission or a PDSCH reception (e.g. if the UE 3 is not provided PDCCHSkippingDurationList). In this case, the XR specific offset may be indicated by setting the field to the value ‘11’ (when 2 bits are present) or by adding at least one new bit (e.g. a third bit). It will be appreciated that a dedicated (XR) offset activation field may be used instead of the PDCCH monitoring adaptation field of a suitable DCI format.
Option 2: XR specific PDCCH monitoring may be supported via specific (new) values of the ‘monitoringSlotPeriodicityAndOffset’ information element. For example, one of the following values may be used: ‘sl8’, ‘sl17’, ‘sl32’, ‘sl33’, ‘sl64’, ‘sl66’, ‘sl128’, ‘sl133’, ‘sl256’, and ‘sl266’. This option will be described in detail with reference to ‘Solution 2’.
Option 3: A suitable DCI field (such as the PDCCH monitoring adaptation field) may be used to set an appropriate jitter offset when necessary. Such a jitter offset may be used to shift the start offset of PDCCH monitoring (by +/−‘jitter offset’ value), for at least one of the periodic PDCCH monitoring occasions. In this case, one bit may be used to select one of two configured values (e.g. −1/+1) for the offset, two bits may be used to select one of four configured values for the offset (e.g. −2/−1/+1/+2), and so on. The values may represent a number of slots for example.

Beneficially, by defining one or more of the above PDCCH monitoring parameters, the UE 3 can optimise its power savings (and it can minimise the number of failed or missed PDCCH receptions) since it knows exactly which slots will carry the search space for a given XR stream (or CG stream if applicable).

### New Definition of Search Space Set Parameter

The monitoringSlotPeriodicityAndOffset information element configures the timing of the search space set based on a formula. For a 30 KHz subcarrier spacing (SCS), there are twenty slots per frame. The search space set occurs during slot(μ, s,f) within a Frame(f) for which the following formula is true:

(Frame(f)×20+slot(μ,s,f)−offset−k(μ)+jitter)mod Periodicity=0

where ‘μ’ is a value associated with the SCS configuration for the cell (see Table 1), ‘s,f’ represents the slot index. Jitter is optional, or it may be ‘0’ by default unless a different value is indicated.
The value of ‘k(μ)’ is given by the following formula:

$$k ( μ ) = ⌈ p * ( 1000 ms / fps * 2 \hat{} μ - periodicity\_slot ) ⌉$$

where ‘p’ is the index of periodicity (p=0, 1, 2, 3, 4, 5, . . . ), and ‘periodicity_slot’ is the Periodicity in the first equation (signalled via the monitoringSlotPeriodicityAndOffset information element).

Effectively, k(μ) represents an additional offset to be applied on top of the offset configured via the monitoringSlotPeriodicityAndOffset information element, and this additional offset depends on the value of ‘μ’ and the index of the periodicity. As a result, the total offset comprises two parts, a static part given by the value of the ‘offset’ in the first equation and a variable part given by ‘k(μ)’.

TABLE 1
transmission numerologies

| μ | Δƒ = 2^{μ} · 15 [kHz] | cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

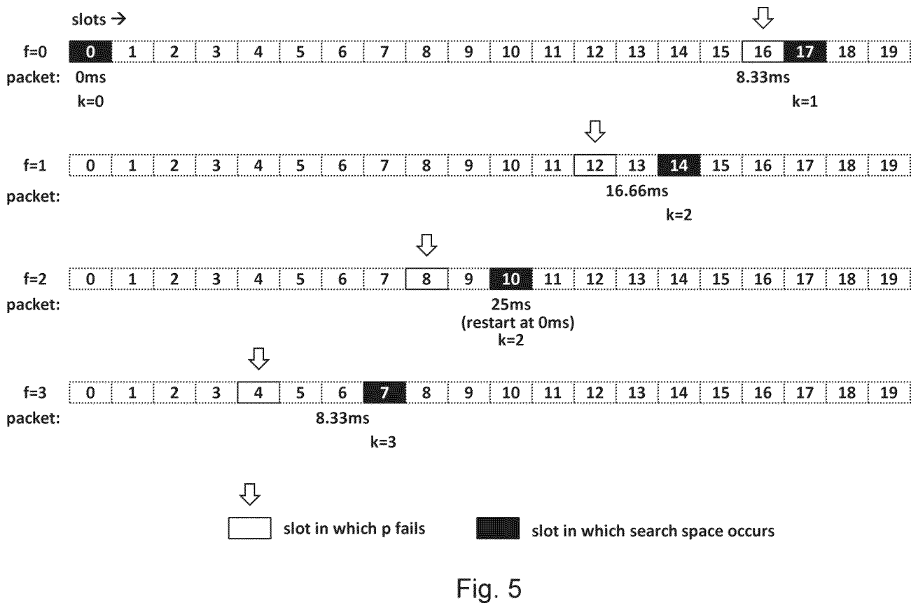

FIG. 5 illustrates schematically an exemplary XR search space configuration for a 8.33 ms stream (corresponding to a 120 fps frame rate) to which the above formulas may be applicable. For the 30 kHz SCS used in this example, there are 20 slots per frame. The following parameters are used: offset=0; periodicity=8 ms; μ=1; fps=120. The offset and the periodicity are configured using an appropriately formatted monitoringSlotPeriodicityAndOffset information element.

In FIG. 5, black slots indicate the slots in which the search space occurs based on the eight slot (i.e. 8 ms) periodicity and the arrows show those slots where the periodicity does not match the actual arriving time of a data packet.

The difference between the actual arrival slot of a data packet (given by multiples of 8.33 ms) and the nearest slot (given by multiples of the 8 ms periodicity) is gradually getting larger, resulting in failure or delay of receiving a particular data packet. In this example, the search space set occurs during slot #0 and slot #17 (in the first frame), slot #34 (which is slot #14 of the second frame), slot #50 (slot #10 of the third frame), slot #67 (slot #7 of the fourth frame), etc. As can be seen, the difference increases to approximately one slot in the first frame (the frame having an index f=0 in this example), further increases to two slots in the second and third frames (f=1 and f=2, respectively), and three slots in the fourth frame (f=3).

Beneficially, for each slot μ the UE 3 is able to derive k(μ) using the above formula. In this example, k=0 for slot #0, k=1 for slot #17, k=2 for slot #34, k=2 for slot #50, k=3 for slot #67, etc. Effectively, the UE 3 (and the network) can use the current value of k as an additional offset (in the above equality formula) to locate the actual slot in which the search space occurs, and the UE 3 can monitor the PDCCH accordingly.

It will be appreciated that the above formulas may be used when the XR specific offset (k) has been activated in accordance with option 1 above. When the XR specific offset is deactivated, the search space set may be determined using the following formula:

$$( Frame ( f ) \times 20 + slot ( μ , s , f ) - offset ) mod Periodicity = 0$$

Alternatively, in a case that a jitter offset value is provided, e.g. as described in option 3) above, the search space set may be determined using the following formula:

$$( Frame ( f ) \times 20 + slot ( μ , s , f ) - offset + jitter ) mod Periodicity = 0$$

### Solution 2

The so-called monitoringSlotPeriodicityAndOffset information element indicates to the UE 3 the slots for PDCCH monitoring. The slots for PDCCH monitoring are configured using a periodicity and an offset. For example, clause of 3GPP TS 38.213 V16.8.0 (NPL 7) specifies that if a UE is configured to monitor DCI format 2_1, only the values ‘sl1’, ‘sl2’, or ‘sl4’ are applicable; if a UE is configured to monitor DCI format 2_0, only the values ‘sl1’, ‘sl2’, ‘sl4’, ‘sl5’, ‘sl8’, ‘sl10’, ‘sl16’, and ‘sl20’ are applicable; and if a UE is configured to monitor DCI format 2_4, only the values ‘sl1’, ‘sl2’, ‘sl4’, ‘sl5’, ‘sl8’, and ‘sl10’ are applicable.

Beneficially, in this system, if the UE 3 is configured to monitor a particular stream (e.g. an XR stream) with a periodicity of 8.33 ms or 16.66 ms, the values ‘sl8’, ‘sl16’, ‘sl32’, ‘sl64’, ‘sl128’, or ‘sl256’ are applicable to that UE 3 (depending on the SCS). In summary, the SearchSpace information element defines how/where to search for PDCCH candidates. Each search space is associated with a control resource set. Further details of the search space configuration using the SearchSpace information element and the monitoringSlotPeriodicityAndOffset information element are shown below, including the values discussed in the present document.

| SearchSpace := | SEQUENCE { | |
|---|---|---|
| searchSpaceId | SearchSpaceId, | |
| controlResourceSetId | ControlResourceSetId | OPTIONAL, |
| | | -- Cond SetupOnly |

| | |
|---|---|
| monitoringSlotPeriodicityAndOffset | CHOICE { |
| sl1 | NULL, |
| sl2 | INTEGER (0..1), |
| sl4 | INTEGER (0..3), |
| sl5 | INTEGER (0..4), |
| sl8 | INTEGER (0..7), SCS= 15KHz, 8ms periodicity |
| sl10 | INTEGER (0..9), |
| sl16 | INTEGER (0..15), SCS= 15KHz, 16ms periodicity |
| | or SCS = 30KHz, 8ms periodicity |
| sl20 | INTEGER (0..19), |
| sl32 | INTEGER (0..31), SCS = 30KHz, 16ms periodicity |
| | or SCS=60KHz, 8ms periodicity |
| sl40 | INTEGER (0..39), |
| sl64 | INTEGER (0..65), SCS = 60KHz, 16ms periodicity |
| | or SCS=120KHz, 8ms periodicity |
| sl80 | INTEGER (0..79), |
| sl128 | INTEGER (0..127), SCS=120KHz, 16ms periodicity |
| | or SCS = 240KHz, 8ms periodicity |
| sl160 | INTEGER (0..159), |
| sl256 | INTEGER (0..254), SCS = 240KHz, 16ms periodicity |
| sl320 | INTEGER (0..319), |
| sl640 | INTEGER (0..639), |
| sl1280 | INTEGER (0..1279), |
| sl2560 | INTEGER (0..2559) |

}

It will be appreciated that the values ‘sl7’, ‘sl33’, ‘sl66’, ‘sl133’ or ‘sl266’ may also be used (which are closer to the 8.33 ms and 16.66 ms periodicities) even though these values are less well aligned with other SCS's or periodicities of CSI-RS.

It will also be appreciated that this scheme may be extended to 480 and 960 kHz SCS as well (by adding associated values to the information element if necessary). However, the UE blind decoding capability for SCS 480 and 960 kHz is based on a group of 4 and 8 slots, respectively. This implies that the UE would decode PDCCH as a group instead of individual slots. Thus, in the case of SCS 480 and 960 kHz, the skipping duration may be based on the group size as the step function. The step function is 4 and 8 slots for 480 and 960 kHz SCS respectively.

### Solution 3

In the DL, a single DCI may schedule multiple slots to deliver the XR packet. In the UL, a burst of configured grant across a number of consecutive slots may be needed to deliver an XR packet. In this case, the start offset of the configured grant is adjusted as discussed in solution 1, such that it includes a configured grant specific period (given in a number of symbols), indicated via the ‘periodicity’ field of the ConfiguredGrantConfig information element.

The ‘periodicity’ field is defined as the periodicity for UL transmission without UL grant for type 1 and type 2. Table 2 illustrates the currently supported periodicities for each subcarrier spacing.

TABLE 2
periodicities

| SCS | Periodicities [symbols] |
|---|---|
| 15 kHz | 2, 7, n*14, where n = {1, 2, 4, |
| | 5, 8, 10, 16, 20, 32, 40, 64, 80, |
| | 128, 160, 320, 640} |
| 30 kHz | 2, 7, n*14, where n = {1, 2, 4, 5, |
| | 8, 10, 16, 20, 32, 40, 64, 80, |
| | 128, 160, 256, 320, 640, 1280} |
| 60 kHz | 2, 7, n*14, where n = {1, 2, 4, 5, |
| (with normal CP) | 8, 10, 16, 20, 32, 40, 64, 80, |
| | 128, 160, 256, 320, 512, 640, 1280, 2560} |
| 60 kHz | 2, 6, n*12, where n = {1, 2, 4, 5, |
| (with ECP) | 8, 10, 16, 20, 32, 40, 64, 80, |
| | 128, 160, 256, 320, 512, 640, 1280, 2560} |
| 120 kHz | 2, 7, n*14, where n = {1, 2, 4, 5, |
| | 8, 10, 16, 20, 32, 40, 64, 80, |
| | 128, 160, 256, 320, 512, 640, |
| | 1024, 1280, 2560, 5120} |

In order to adjust the start offset of the configured grant, a symbol level offset is used. In this example, this symbol level offset which is referred to as ‘kOffsetSymbols’ and it is derived using the following formula:

$$kOffsetSymbols = ⌈ ( 1000 ms / fps * 2 \hat{} μ * numberOfSymbolsPerSlot - periodicity\_sym ) * N ⌉$$

where ‘N’ is for N^{th} grant, and ‘periodicity_sym’ is the applicable periodicity (configured based on Table 2).

3GPP TS 38.321 V16.7.0 (NPL 8) section 5.8.2 includes formulas for determining the position of the configured uplink grant based on a number of parameters. In this case, for improved support for XR traffic, a symbol level offset is achieved by adapting the formulas to include the value of the ‘kOffsetSymbols’ derived using the above approach.

In more detail, after an uplink grant is configured for a configured grant Type 1, the MAC entity shall consider sequentially that the N^{th} (N>=0) uplink grant occurs in the symbol for which:

[(SFN×numberOfSlotsPerFrame×numberOfSymbolsPerSlot)+(slot number in the frame×numberOfSymbolsPerSlot)+symbol number in the slot]=(timeReferenceSFN×numberOfSlotsPerFrame×numberOfSymbolsPerSlot+timeDomainOffset×numberOfSymbolsPerSlot+startSymbol+N×periodicity+kOffsetSymbols)modulo(1024×numberOfSlotsPerFrame×numberOfSymbolsPerSlot).

After an uplink grant is configured for a configured grant Type 2, the MAC entity shall consider sequentially that the N^{th} (N>=0) uplink grant occurs in the symbol for which:

[(SFN×numberOfSlotsPerFrame×numberOfSymbolsPerSlot)+(slot number in the frame×numberOfSymbolsPerSlot)+symbol number in the slot]=[(SFN_{start time}×numberOfSlotsPerFrame×numberOfSymbolsPerSlot+slot_{start time}×numberOfSymbolsPerSlot+symbol_{start time})+N×periodicity+kOffsetSymbols]modulo(1024×numberOfSlotsPerFrame×numberOfSymbolsPerSlot).

where SFN_{start time}, slot_{start time}, and symbol_{start time} are the SFN, slot, and symbol, respectively, of the first transmission opportunity of PUSCH where the configured uplink grant was (re-)initialised.

Once the start (symbol/slot) of the configured uplink grant has been determined (e.g. based on the ‘kOffsetSymbols’), the UE 3 can transmit uplink data for a given duration. The duration refers to the number of consecutive slots of the configured grant burst which may be indicated using a suitable DCI field (a new one or by reusing an existing one, such as the ‘cg-nrofSlots’ field). The resource allocation may be based on average/median packet size or a 90%-tile packet size and it may be suitable for most cases where the packet size variation is relatively small. In a small number of time instances, where configured grant resources are insufficient, additional resources may be requested using dynamic scheduling.

Currently, if cg-nrofSlots is configured for a configured grant Type 1 or Type 2, the MAC entity shall consider the uplink grants occur in those additional PUSCH allocations as specified in clause 6.1.2.3 of 3GPP TS 38.214 V16.8.0 (NPL 9). For the determination of the PUSCH repetition type, if the higher layer parameter pusch-RepTypeIndicator in rrc-ConfiguredUplinkGrant is configured and set, then for both Type 1 and Type 2 PUSCH transmissions with a configured grant, when K>1, the UE shall repeat the Transport Block (TB) across the K consecutive slots applying the same symbol allocation in each slot, except if the UE is provided with higher layer parameters cg-nrofSlots and cg-nrofPUSCH-InSlot, in which case the UE repeats the TB in the repK earliest consecutive transmission occasion candidates within the same configuration.

Currently, only the same transport block can be transmitted in the K consecutive slots of a configured grant allocation. However, in this system, the parameter ‘cg-nrofSlots’ may be reused to transmit different transport blocks if PUSCH repetition type is not set. Thus, in this case, the parameter ‘cg-nrofSlots’ is configured to indicate the duration (i.e. the number of consecutive slots) for the uplink transmission within the current configured grant burst.

### Modifications and Alternatives

Detailed example embodiments have been described above. As those skilled in the art will appreciate, a number of modifications and alternatives can be made to the above example embodiments whilst still benefiting from the disclosures embodied therein. By way of illustration only a number of these alternatives and modifications will now be described.

It will be appreciated that a higher layer parameter of frame rate may be used to configure the ‘frame per second’ for XR. This parameter can be used by the UE to calculate kOffsetSymbols and k(μ), and it can be part of the Data Radio Bearer (DRB) configuration or the MAC configuration.

It will be appreciated that the above example embodiments may be applied to both 5G New Radio and LTE systems (E-UTRAN). The above example embodiments may also be applied to future systems (beyond 5G, 6G, etc.).

In the above description, the UE, the access network node (base station), and the core network node are described for ease of understanding as having a number of discrete modules (such as the communication control modules). Whilst these modules may be provided in this way for certain applications, for example where an existing system has been modified to implement the present disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

The software module or the program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above example embodiments, a number of software modules were described. As those skilled in the art will appreciate, the software modules may be provided in compiled or un-compiled form and may be supplied to the UE, the access network node (base station), and the core network node as a signal over a computer network, or on a recording medium. Further, the functionality performed by part or all of this software may be performed using one or more dedicated hardware circuits. However, the use of software modules is preferred as it facilitates the updating of the UE, the access network node, and the core network node in order to update their functionalities.

It will be appreciated that the functionality of a base station (referred to as a ‘distributed’ base station or gNB) may be split between one or more distributed units (DUs) and a central unit (CU) with a CU typically performing higher level functions and communication with the next generation core and with the DU performing lower level functions and communication over an air interface with UEs in the vicinity (i.e. in a cell operated by the gNB). A distributed gNB includes the following functional units:

gNB Central Unit (gNB-CU): a logical node hosting Radio Resource Control (RRC), Service Data Adaptation Protocol (SDAP) and Packet Data Convergence Protocol (PDCP) layers of the gNB (or RRC and PDCP layers of an en-gNB) that controls the operation of one or more gNB-DUs. The gNB-CU terminates the so-called F1 interface connected with the gNB-DU.

gNB Distributed Unit (gNB-DU): a logical node hosting Radio Link Control (RLC), Medium Access Control (MAC) and Physical (PHY) layers of the gNB or en-gNB, and its operation is partly controlled by gNB-CU. One gNB-DU supports one or multiple cells. One cell is supported by only one gNB-DU. The gNB-DU terminates the F1 interface connected with the gNB-CU.

gNB-CU-Control Plane (gNB-CU-CP): a logical node hosting the RRC and the control plane part of the PDCP protocol of the gNB-CU for an en-gNB or a gNB. The gNB-CU-CP terminates the so-called E1 interface connected with the gNB-CU-UP and the F1-C(F1 control plane) interface connected with the gNB-DU.

gNB-CU-User Plane (gNB-CU-UP): a logical node hosting the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U (F1 user plane) interface connected with the gNB-DU.

It will be appreciated that when a distributed base station or a similar control plane-user plane (CP-UP) split is employed, the base station may be split into separate control-plane and user-plane entities, each of which may include an associated transceiver circuit, antenna, network interface, controller, memory, operating system, and communications control module. When the base station comprises a distributed base station, the network interface (reference numeral 55 in FIG. 3) also includes an E1 interface and an F1 interface (F1-C for the control plane and F1-U for the user plane) to communicate signals between respective functions of the distributed base station. In this case, the communications control module is also responsible for communications (generating, sending, and receiving signalling messages) between the control-plane and user-plane parts of the base station. It will be appreciated that when a distributed base station is used there is no need to involve both the control-plane and user-plane parts for pre-emption of communication resources as described in the above example embodiments. It will be appreciated that pre-emption may be handled by the user-plane part of the base station without involving the control-plane part (or vice versa).

The above example embodiments are also applicable to ‘non-mobile’ or generally stationary user equipment. The above described mobile device may comprise an MTC/IoT device and/or the like.

The User Equipment (or “UE”, “mobile station”, “mobile device” or “wireless device”) in the present disclosure is an entity connected to a network via a wireless interface.

It should be noted that the present disclosure is not limited to a dedicated communication device, and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to ‘internet of things’ (IoT), using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table (source: 3GPP TS 22.368 V13.1.0 (NPL 10), Annex B, the contents of which are incorporated herein by reference). This list is not exhaustive and is intended to be indicative of some examples of machine type communication applications.

| Service Area | MTC applications |
|---|---|
| Security | Surveillance systems |
| | Backup for landline |
| | Control of physical access (e.g. to buildings) |
| | Car/driver security |
| Tracking & | Fleet Management |
| Tracing | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote | Sensors |
| Maintenance/ | Lighting |
| Control | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer | Digital photo frame |
| Devices | Digital camera |
| | eBook |

Applications, services, and solutions may be an Mobile Virtual Network Operator (MVNO) service, an emergency radio communication system, a Private Branch eXchange (PBX) system, a PHS/Digital Cordless Telecommunications system, a Point of sale (POS) system, an advertise calling system, a Multimedia Broadcast and Multicast Service (MBMS), a Vehicle to Everything (V2X) system, a train radio system, a location related service, a Disaster/Emergency Wireless Communication Service, a community service, a video streaming service, a femto cell application service, a Voice over LTE (VoLTE) service, a charging service, a radio on demand service, a roaming service, an activity monitoring service, a telecom carrier/communication NW selection service, a functional restriction service, a Proof of Concept (PoC) service, a personal information management service, an ad-hoc network/Delay Tolerant Networking (DTN) service, etc.

Further, the above-described UE categories are merely examples of applications of the technical ideas and example embodiments described in the present document. Needless to say, these technical ideas and example embodiments are not limited to the above-described UE and various modifications can be made thereto.

The adjusting the value of the first offset may include calculating an offset adjustment value using at least one formula. The offset adjustment value may be determined using the formula:

$$k ( μ ) = ⌈ p * ( 1000 ms / fps * 2 \hat{} μ - periodicity\_slot ) ⌉$$

where ‘k(μ)’ is the offset adjustment value, ‘p’ is an index of packet arrival for the data stream, ‘fps’ is the frame rate associated with the data stream, ‘μ’ is a value associated with a subcarrier spacing, and ‘periodicity_slot’ is the search space periodicity in unit of slots.

The method performed by the UE may further comprise determining that the search space occurs in a slot(μ, s,f) within Frame(f) in a case that the following equality is true for that slot:

$$( Frame ( f ) \times 20 + slot ( μ , s , f ) - offset - k ( μ ) ) mod Periodicity = 0$$

where ‘offset’ is the first offset, ‘k(μ)’ is the offset adjustment value, ‘μ’ is a value associated with a subcarrier spacing, and ‘Periodicity’ is the search space periodicity in unit of slots.

The method performed by the UE may further comprise determining that the search space occurs in a particular slot(μ, s,f) within Frame(f) in a case that the following equality is true for that slot:

$$( Frame ( f ) \times 20 + slot ( μ , s , f ) - offset - k ( μ ) + jitter ) mod Periodicity = 0$$

where ‘offset’ is the first offset, ‘k(μ)’ is the offset adjustment value, ‘jitter’ is a value of jitter associated with the data stream, ‘μ’ is a value indicating a subcarrier spacing, and ‘Periodicity’ is the search space periodicity in unit of slots.

The configuration information may be included in a monitoringSlotPeriodicityAndOffset information element.

The method performed by the UE may further comprise activating or deactivating the adjusting of the first offset for the data stream based on a field of a Downlink Control Information (DCI) format. The method performed by the UE may comprise activating or deactivating the adjusting of the first offset in a case that a ‘PDCCH Monitoring Adaptation’ field of the DCI format is set to the value of ‘11’.

The method performed by the UE may further comprise: receiving information identifying a further offset relating to a jitter associated with the data stream; and adjusting the first offset based on the further offset. The information identifying the further offset may be included in a field of a DCI format.

The first periodicity may be defined as a number of slots between consecutive search spaces, and a value of the first periodicity may be set to one of: 8 slots; 17 slots; 32 slots; 33 slots; 64 slots; 66 slots; 128 slots; 133 slots; 256 slots; and 266 slots. The first periodicity may be set to one of the values ‘sl8’, ‘sl17’, ‘sl32’, ‘sl33’, ‘sl64’, ‘sl66’, ‘sl128’, ‘sl133’, ‘sl256’, and ‘sl266’ in the monitoringSlotPeriodicityAndOffset information element.

The method performed by the UE may further comprise monitoring the search space for a physical downlink control channel (PDCCH) associated with the data stream.

The data stream may be related to at least one of an extended reality service and a cloud gaming service.

The configuration information may be for a configured grant associated with the data stream, the first periodicity may be for the configured grant, the offset may be a slot level offset, and the method may comprise adjusting the slot level offset using a symbol level offset derived based on the frame rate or the periodicity associated with the data stream.

The symbol level offset may be derived using a formula. For example, the symbol level offset may be derived using the formula:

$$kOffsetSymbols = ⌈ ( 1000 ms / fps * 2 \hat{} μ * numberOfSymbolsPerSlot - periodicity\_sym ) * N ⌉$$

where ‘kOffsetSymbols’ is the symbol level offset, ‘fps’ is the frame rate associated with the data stream, ‘μ’ is a value indicating a subcarrier spacing, ‘periodicity_sym’ is the configured grant periodicity in unit of symbols, and ‘N’ is for the N^{th} grant.

The method performed by the UE may further comprise determining that the search space occurs in a particular symbol in a case that:
after an uplink grant is configured for a configured grant Type 1, the N^{th} (N>=0) uplink grant occurs in the symbol for which:

[(SFN×numberOfSlotsPerFrame×numberOfSymbolsPerSlot)+(slot number in the frame×numberOfSymbolsPerSlot)+symbol number in the slot]=(timeReferenceSFN×numberOfSlotsPerFrame×numberOfSymbolsPerSlot+timeDomainOffset×numberOfSymbolsPerSlot+startSymbol+N×periodicity+kOffsetSymbols)modulo(1024×numberOfSlotsPerFrame×numberOfSymbolsPerSlot)
after an uplink grant is configured for a configured grant Type 2, the N^{th} (N>=0) uplink grant occurs in the symbol for which:

[(SFN×numberOfSlotsPerFrame×numberOfSymbolsPerSlot)+(slot number in the frame×numberOfSymbolsPerSlot)+symbol number in the slot]=[(SFN_{start time}×numberOfSlotsPerFrame×numberOfSymbolsPerSlot+slot_{start time}×numberOfSymbolsPerSlot+symbol_{start time})+N×periodicity+kOffsetSymbols]modulo(1024×numberOfSlotsPerFrame×numberOfSymbolsPerSlot)

where SFN_{start time}, slot_{start time}, and symbol_{start time} are a system frame number (SFN), a slot, and a symbol, respectively, of a first transmission opportunity of a Physical Downlink Shared Channel (PUSCH) where the configured uplink grant was (re-)initialised, ‘periodicity’ is the configured grant periodicity in unit of symbols, ‘N’ is for the N^{th} grant, and ‘kOffsetSymbols’ is the symbol level offset.

The method performed by the UE may further comprise determining a number of consecutive slots of the configured uplink grant burst based on information included in a field of a Downlink Control Information (DCI) format or a field of a Radio Resource Control (RRC) information element.

The RRC information element may include a ‘cg-nrofSlots’ field adapted to control transmission of different transport blocks if a PUSCH repetition type is not set, and the method performed by the UE may comprise determining the number of consecutive slots of the configured uplink grant burst based on the ‘cg-nrofSlots’ field.

The method performed by the UE may further comprise receiving a Data Radio Bearer (DRB) or a Medium Access Control (MAC) configuration relating to the data stream, the DRB or MAC configuration including information identifying the frame rate associated with the data stream.

Various other modifications will be apparent to those skilled in the art and will not be described in further detail here.

The previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

This application is based upon and claims the benefit of priority from United Kingdom patent application No. 2205935.6, filed on Apr. 22, 2022, the disclosure of which is incorporated herein in its entirety by reference.

The whole or part of the example embodiments disclosed above can be described as, but not limited to, the following supplementary notes.

### Supplementary Note 1

A method performed by a user equipment (UE), the method comprising:
receiving configuration information for determining at least one position of a resource for transmission/reception associated with a data stream, the configuration information including information identifying a first periodicity and information identifying an offset; and
adjusting the offset based on a frame rate or a second periodicity associated with the data stream.

### Supplementary Note 2

The method according to Supplementary note 1, wherein
the configuration information is for monitoring of a search space associated with the data stream,
the first periodicity is for the monitoring of the search space, and
the offset is a first offset.

### Supplementary Note 3

The method according to Supplementary note 2, wherein the adjusting the value of the first offset includes calculating an offset adjustment value using at least one formula.

### Supplementary Note 4

The method according to Supplementary note 3, wherein the offset adjustment value is determined using the formula:

$$k ( μ ) = ⌈ p * ( 1000 ms / fps * 2 \hat{} μ - periodicity\_slot ) ⌉$$

where ‘k(μ)’ is the offset adjustment value, ‘p’ is an index of packet arrival for the data stream, ‘fps’ is the frame rate associated with the data stream, ‘μ’ is a value associated with a subcarrier spacing, and ‘periodicity_slot’ is the search space periodicity in unit of slots.

### Supplementary Note 5

The method according to Supplementary note 3 or 4, further comprising determining that the search space occurs in a slot(μ, s,f) within Frame(f) in a case that the following equality is true for that slot:

$$( Frame ( f ) \times 20 + slot ( μ , s , f ) - offset - k ( μ ) ) mod Periodicity = 0$$

where ‘offset’ is the first offset, ‘k(μ)’ is the offset adjustment value, ‘μ’ is a value associated with a subcarrier spacing, and ‘Periodicity’ is the search space periodicity in unit of slots.

### Supplementary Note 6

The method according to Supplementary note 3 or 4, further comprising determining that the search space occurs in a particular slot(μ, s,f) within Frame(f) in a case that the following equality is true for that slot:

$$( Frame ( f ) \times 20 + slot ( μ , s , f ) - offset - k ( μ ) + jitter ) mod Periodicity = 0$$

where ‘offset’ is the first offset, ‘k(μ)’ is the offset adjustment value, ‘jitter’ is a value of jitter associated with the data stream, ‘μ’ is a value indicating a subcarrier spacing, and ‘Periodicity’ is the search space periodicity in unit of slots.

### Supplementary Note 7

The method according to any of Supplementary notes 2 to 6, wherein the configuration information is included in a monitoringSlotPeriodicityAndOffset information element.

### Supplementary Note 8

The method according to any of Supplementary notes 2 to 7, further comprising activating or deactivating the adjusting of the first offset for the data stream based on a field of a Downlink Control Information (DCI) format.

### Supplementary Note 9

The method according to any of Supplementary notes 2 to 8, comprising activating or deactivating the adjusting of the first offset in a case that a ‘PDCCH Monitoring Adaptation’ field of the DCI format is set to the value of ‘11’.

### Supplementary Note 10

The method according to any of Supplementary notes 2 to 9, further comprising:
receiving information identifying a further offset relating to a jitter associated with the data stream; and
adjusting the first offset based on the further offset.

### Supplementary Note 11

The method according to Supplementary note 10, wherein the information identifying the further offset is included in a field of a DCI format.

### Supplementary Note 12

The method according to any of Supplementary notes 2 to 11, wherein the first periodicity is defined as a number of slots between consecutive search spaces, and a value of the first periodicity is set to one of: 8 slots; 17 slots; 32 slots; 33 slots; 64 slots; 66 slots; 128 slots; 133 slots; 256 slots; and 266 slots.

### Supplementary Note 13

The method according to any of Supplementary notes 2 to 12, wherein the first periodicity is set to one of the values ‘sl8’, ‘sl7’, ‘sl32’, ‘sl33’, ‘sl64’, ‘sl66’, ‘sl128’, ‘sl133’, ‘sl256’, and ‘sl266’ in the monitoringSlotPeriodicityAndOffset information element.

### Supplementary Note 14

The method according to any of Supplementary notes 2 to 13, further comprising monitoring the search space for a physical downlink control channel (PDCCH) associated with the data stream.

### Supplementary Note 15

The method according to any of Supplementary notes 2 to 14, wherein the data stream is related to at least one of an extended reality service and a cloud gaming service.

### Supplementary Note 16

The method according to Supplementary note 1, wherein
the configuration information is for a configured grant associated with the data stream,
the first periodicity is for the configured grant,
the offset is a slot level offset, and
the method comprises adjusting a symbol level offset derived based on the frame rate or the second periodicity associated with the data stream.

### Supplementary Note 17

The method according to Supplementary note 16, wherein the symbol level offset is derived using a formula.

### Supplementary Note 18

The method according to Supplementary note 16 or 17, wherein the symbol level offset is derived using the formula:

$$kOffsetSymbols = ⌈ ( 1000 ms / fps * 2 \hat{} μ * numberOfSymbolsPerSlot - periodicity\_sym ) * N ⌉$$

where ‘kOffsetSymbols’ is the symbol level offset, ‘fps’ is the frame rate associated with the data stream, ‘μ’ is a value indicating a subcarrier spacing, ‘periodicity_sym’ is the configured grant periodicity in unit of symbols, and ‘N’ is for the N^{th} grant.

### Supplementary Note 19

The method according to any of Supplementary notes 16 to 18, further comprising determining that the search space occurs in a particular symbol in a case that:
after an uplink grant is configured for a configured grant Type 1, the N^{th} (N>=0) uplink grant occurs in the symbol for which:

[(SFN×numberOfSlotsPerFrame×numberOfSymbolsPerSlot)+(slot number in the frame×numberOfSymbolsPerSlot)+symbol number in the slot]=(timeReferenceSFN×numberOfSlotsPerFrame×numberOfSymbolsPerSlot+timeDomainOffset×numberOfSymbolsPerSlot+startSymbol+N×periodicity+kOffsetSymbols)modulo(1024×numberOfSlotsPerFrame×numberOfSymbolsPerSlot)
after an uplink grant is configured for a configured grant Type 2, the N^{th} (N>=0) uplink grant occurs in the symbol for which:

[(SFN×numberOfSlotsPerFrame×numberOfSymbolsPerSlot)+(slot number in the frame×numberOfSymbolsPerSlot)+symbol number in the slot]=[(SFN_{start time}×numberOfSlotsPerFrame×numberOfSymbolsPerSlot+slot_{start time}×numberOfSymbolsPerSlot+symbol_{start time})+N×periodicity+kOffsetSymbols]modulo(1024×numberOfSlotsPerFrame×numberOfSymbolsPerSlot)

where SFN_{start time}, slot_{start time}, and symbol_{start time} are a system frame number (SFN), a slot, and a symbol, respectively, of a first transmission opportunity of a Physical Downlink Shared Channel (PUSCH) where the configured uplink grant was (re-)initialised, ‘periodicity’ is the configured grant periodicity in unit of symbols, ‘N’ is for the N^{th} grant, and ‘kOffsetSymbols’ is the symbol level offset.

### Supplementary Note 20

The method according to any of Supplementary notes 16 to 19, further comprising determining a number of consecutive slots of the configured uplink grant burst based on information included in a field of a Downlink Control Information (DCI) format or a field of a Radio Resource Control (RRC) information element.

### Supplementary Note 21

The method according to Supplementary note 20, wherein the RRC information element includes a ‘cg-nrofSlots’ field adapted to control transmission of different transport blocks if a PUSCH repetition type is not set, and the method comprises determining the number of consecutive slots of the configured uplink grant burst based on the ‘cg-nrofSlots’ field.

### Supplementary Note 22

The method according to any of Supplementary notes 1 to 21, further comprising receiving a Data Radio Bearer (DRB) or a Medium Access Control (MAC) configuration relating to the data stream, the DRB or MAC configuration including information identifying the frame rate associated with the data stream.

### Supplementary Note 23

A method performed by a base station, the method comprising:
transmitting, to a user equipment (UE), configuration information for determining at least one position of a resource for transmission/reception associated with a data stream, the configuration information including information identifying a first periodicity and information identifying an offset; and
adjusting the offset in a unit of slots or a unit of symbols based on a frame rate associated with the data stream.

### Supplementary Note 24

A user equipment (UE) comprising:
means for receiving configuration information for determining at least one position of a resource for transmission/reception associated with a data stream, the configuration information including information identifying a first periodicity and information identifying an offset; and
means for adjusting the offset based on a frame rate or a second periodicity associated with the data stream.

### Supplementary Note 25

A base station comprising:
means for transmitting, to a user equipment (UE), configuration information for determining at least one position of a resource for transmission/reception associated with a data stream, the configuration information including information identifying a first periodicity and information identifying an offset; and
means for adjusting the offset in a unit of slots or a unit of symbols based on a frame rate associated with the data stream.

### REFERENCE SIGNS LIST

1 Telecommunication system
3, 3A, 3B Mobile device, UE
5 Base station, (R)AN node
7 Core network
10 Control Plane Function (CPF)
11 User Plane Function (UPF)
20 Data network
31 Transceiver circuit
33 Antenna
35 User interface
37 Controller
39 Memory
41 Operating system
43 Communications control module
45 Power saving module
51 Transceiver circuit
53 Antenna
55 Network interface
57 Controller
59 Memory
61 Operating system
63 Communications control module
65 Power saving control module
71 Transceiver circuit
75 Network interface
77 Controller
79 Memory
81 Operating system
83 Communications control module

What is claimed is:

1. A method performed by a user equipment (UE), the method comprising:
receiving configuration information for determining at least one position of a resource for transmission/reception of different transport blocks corresponding to a data stream, in a case where repetition of transmission/reception of transport blocks is not supported, the configuration information including information indicating a duration in at least one consecutive slot of transmission/reception occasions for the data stream in a period within a current configured grant configuration; and
performing the transmission/reception of the different transport blocks corresponding to the data stream in the at least one consecutive slot during the duration.

2. The method according to claim 1, wherein
the configuration information is for monitoring of a search space corresponding to the data stream, and
the duration is for the monitoring of the search space.

3. The method according to claim 2, further comprising:
adjusting the performing the transmission/reception of the different transport blocks by calculating an adjustment value for the transmission/reception of the different transport blocks.

4-7. (canceled)

8. The method according to claim 3, further comprising:
activating or deactivating the adjusting based on information included in Downlink Control Information (DCI).

9. (canceled)

10. The method according to claim 3, further comprising:
receiving information indicating an offset corresponding to a jitter corresponding to the data stream, and wherein
the adjusting is performed based on the offset.

11. The method according to claim 10, wherein the information indicating the offset is included in DCI.

12-15. (canceled)

16. The method according to claim 3, wherein
the adjusting is performed by a symbol level based on a frame rate or a periodicity corresponding to the data stream.

17-19. (canceled)

20. The method according to claim 1, further comprising:
determining a number of consecutive slots of configured uplink grant burst for the data stream, based on information included in Downlink Control Information (DCI) or Radio Resource Control (RRC) message.

21. (canceled)

22. The method according to claim 1, further comprising:
receiving a Data Radio Bearer (DRB) or a Medium Access Control (MAC) configuration corresponding to the data stream, wherein
the DRB or MAC configuration includes information indicating a frame rate corresponding to the data stream.

23. A method performed by a base station, the method comprising:
transmitting, to a user equipment (UE), configuration information for determining at least one position of a resource for transmission/reception of different transport blocks corresponding to a data stream, in a case where repetition of transmission/reception of transport blocks is not supported, the configuration information including information indicating a duration in at least one consecutive slot of transmission/reception occasions for the data stream in a period within a current configured grant configuration; and
performing the transmission/reception of the different transport blocks corresponding to the data stream in the at least one consecutive slot during the duration.

24. A user equipment (UE) comprising:
a memory storing instructions; and
at least one processor configured to process the instructions to:
receive configuration information for determining at least one position of a resource for transmission/reception of different transport blocks corresponding to a data stream, in a case where repetition of transmission/reception of transport blocks is not supported, the configuration information including information indicating a duration in at least one consecutive slot of transmission/reception occasions for the data stream in a period within a current configured grant configuration; and
perform the transmission/reception of the different transport blocks corresponding to the data stream in the at least one consecutive slot during the duration.

25. A base station comprising:
a memory storing instructions; and
at least one processor configured to process the instructions to:
transmit, to a user equipment (UE), configuration information for determining at least one position of a resource for transmission/reception of different transport blocks corresponding to a data stream, in a case where repetition of transmission/reception of transport blocks is not supported, the configuration information including information indicating a duration in at least one consecutive slot of transmission/reception occasions for the data stream in a period within a current configured grant configuration; and
perform the transmission/reception of the different transport blocks corresponding to the data stream in the at least one consecutive slot during the duration.

26. The method according to claim 1, wherein
the performing includes performing the transmission/reception of the different transport blocks corresponding to the data stream per slot.
